(19) United States
(12) Patent Application Publication
(10) Pub. No.: US 2002/0066846 A1
(43) Pub. Date: Jun. 6, 2002

(54) Visor and document holder for a computer monitor

(76) Inventors: Jean W. Giulie, Medford, OR (US); Joe D. Giulie, Medford, OR (US)

Correspondence Address: Bruce H. Johnsonbaugh, Eckhoff & Hoppe, Suite 3125, 333 Market Street, San Francisco, CA, 94105, US

(21) Appl. No.: 10/053,789

(22) Filed: Jan. 24, 2002

Related U.S. Application Data
(63) Continuation-in-part of application No. 09/489,307, filed on Jan. 21, 2000, now abandoned.

(51) Int. Cl. B41J 11/02

(52) U.S. Cl. 248/442.2

(57) ABSTRACT

A visor and document holder for a computer monitor is provided. The preferred embodiment includes a rectangular top member and first and second generally L-shaped side walls that cooperate with the top member to form a shroud extending perpendicularly to the screen plane. Side panels are carried by the side walls and extend in planes generally parallel to the screen plane to block light emanating from behind the computer screen from impinging on the user's eyes and causing unwanted constriction of the pupils. The visor/document holder has a center of gravity that lies forward of the computer monitor, causing a tendency of the device to sag and lose its vertical orientation. A pair of support tabs rest against the front wall of the monitor and prevents sagging and retains the vertical orientation of the device.

### CROSS-REFERENCE TO RELATED APPLICATION

This is a continuation-in-part of U.S. patent application Ser. No. 09/489,307 filed Jan. 21, 2000.

### BACKGROUND AND SUMMARY OF THE INVENTION

The present invention relates generally to an apparatus for reducing glare on computer monitor screens, for reducing unwanted constriction of the user's pupils caused by background light, and for supporting documents adjacent the screen. More particularly, the preferred embodiment of the present invention provides an extremely simple, yet versatile, adjustable visor and document holder which retains its vertical orientation over time.

The prior art includes a variety of shields or visors to help reduce glare. For example, U.S. Pat. No. 4,444,465 teaches an adjustable three-piece shield. U.S. Pat. No. 5,769,378 includes glare reducing members as well as a document support assembly. Both of these prior art patents utilize an anti-glare assembly which extends perpendicularly to the plane of the computer screen. These prior art devices tend to lose their vertical orientation over time, because the center of gravity of those visors is forward of the front wall of the monitor.

The prior art also includes computer monitor assemblies which primarily support documents. For example, U.S. Pat. No. 5,499,793 teaches a hinged copy holding device and a dust cover which protects the screen and keyboard from dust. U.S. Pat. No. 5,383,642 teaches a somewhat complex device for supporting documents close to a computer screen, but does not teach the use of a glare reducing visor for use in conjunction with the document holder. U.S. Pat. No. 5,931,437 teaches a document support wherein clipboard assemblies are attached to vertical handlebars. This patent does not teach the use of an anti-glare visor for use in conjunction with the document support.

The present invention provides a very simple but effective visor for reducing glare on a computer screen, increasing privacy for information displayed on the screen and which simultaneously provides adjustable document holders adjacent the screen, while also retaining its vertical orientation over time.

The present invention prevents light from behind the computer monitor impinging on the user's eyes, causing the user's pupils to constrict, making it more difficult for the user to read the computer screen.

An additional benefit of the invention is that it includes side panels which reduce glare and which simultaneously allow documents and similar reference material to be viewed alongside and in close proximity to the screen. The user, therefore, does not have to look away to a page holder or down at the desk.

Further objects and advantages of the invention will become apparent from the following description and drawings wherein:

### BRIEF DESCRIPTION OF THE DRAWINGS

FIG. 1 is a perspective view of the invention shown connected to a typical computer monitor;

FIG. 2 is a schematic representation showing the apparatus of FIG. 1 and how it reduces glare when used by a typical user;

FIG. 3 is a schematic representation of the invention shown in FIG. 1 showing how the side panels are hinged;

FIG. 4 is a schematic representation of a second embodiment of the invention showing adjustable side panels;

FIG. 5 is a schematic representation of a third embodiment of the invention showing one type of top panel;

FIG. 6 is a schematic representation showing a fourth form of the invention having an elongated top panel;

FIG. 7 shows the first embodiment of the invention and how it may be adjusted in a direction perpendicular to the screen plane of the computer monitor;

FIG. 8 is a schematic representation showing a fifth form of the invention having a fixed length top panel;

FIG. 9 is a front view of the visor shown in FIG. 1;

FIG. 10 is a side view of the visor shown in FIG. 1; and

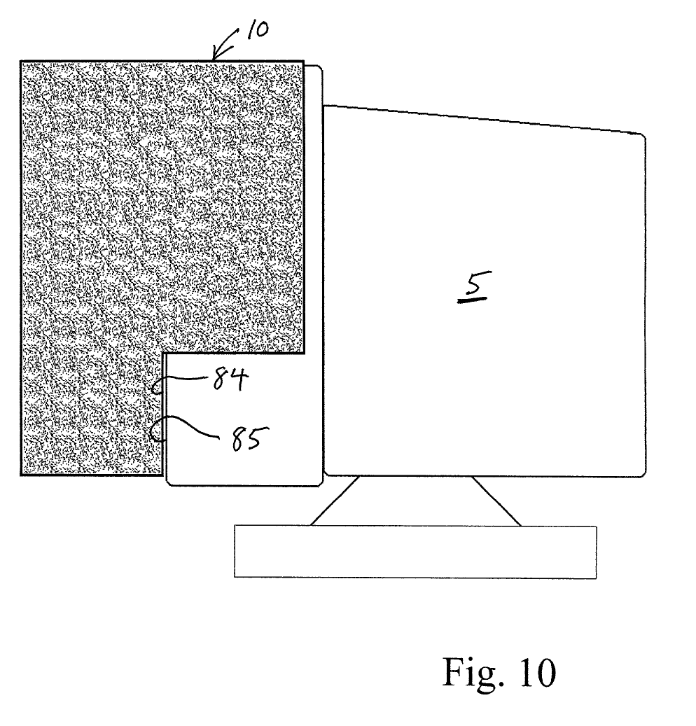

FIGS. 11A and 11B are schematic representations illustrating how prior art visors lose their vertical orientation over time.

### DETAILED DESCRIPTION OF THE DRAWINGS

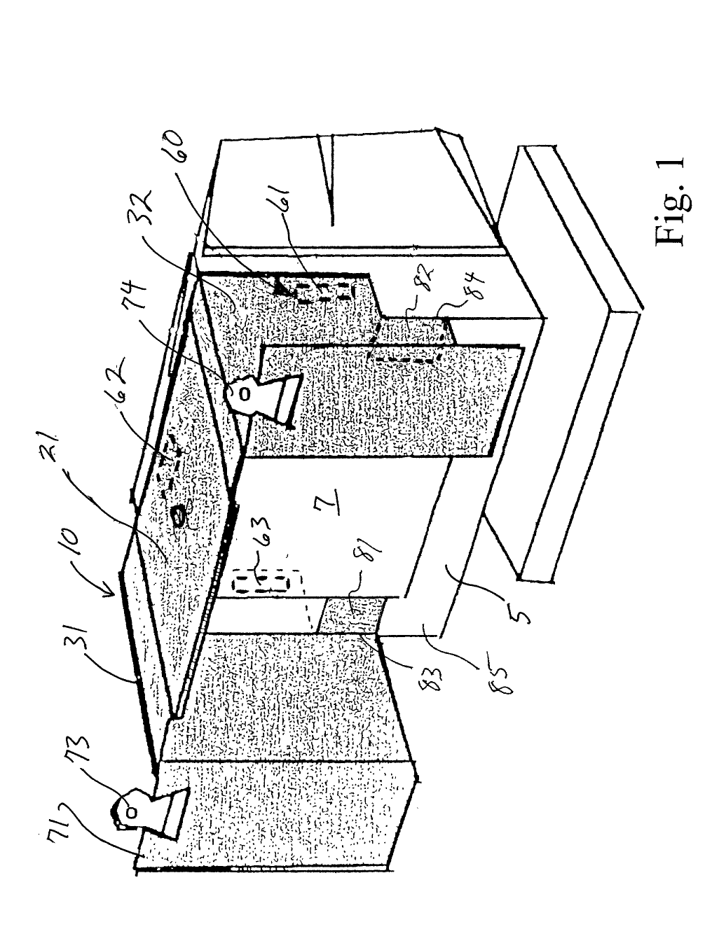

FIGS. 1, 2 and 3 show a first embodiment of the invention which is adjustable; other embodiments described herein are not adjustable or are adjustable in different ways. The adjustable visor and document holder is shown generally as 10 and is shown mounted to a standard computer monitor 5 having a screen 7.

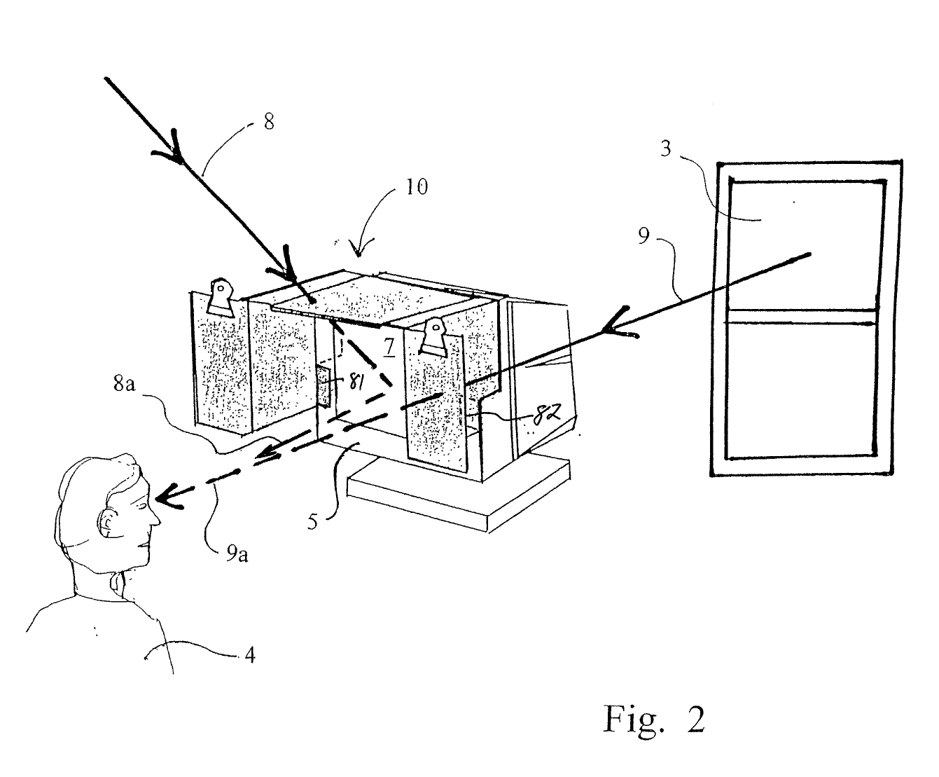

FIG. 2 illustrates schematically how the present invention significantly reduces glare and unwanted background light. A user 4 is positioned in front of the screen 7. Light fixtures above and behind the user produce a light beam 8 which would ordinarily reflect off the screen and into the user's face as shown by arrow 8a. Similarly, light entering a window 3 positioned behind the computer monitor 5 produces light 9 which, in the absence of the adjustable visor 10, would impinge directly on the user's eyes, as shown by arrow 9a. This background light 9 would tend to cause the user's pupils to constrict, which tends to make it difficult for the user to read material displayed on the screen 7.

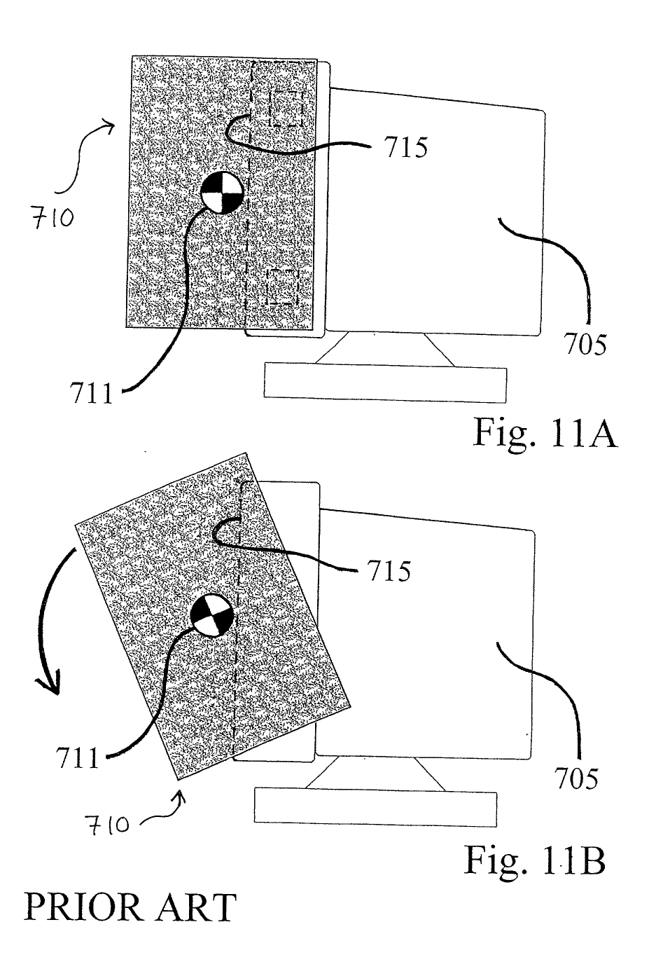

The present invention constitutes an improvement over U.S. Pat. No. 4,444,465, which patent is hereby incorporated by reference as if set forth in full. The problem with the device of the '465 patent is illustrated in exaggerated fashion in FIGS. 11A and 11B. FIGS. 11A and 11B show that over a period of time, the prior art visor 710 will slowly sag from its vertical position of FIG. 1 1 A to its sagging position of FIG. 11B. The center of gravity 711 of visor 710 is forward of the front face 715 of monitor 705. The fact that the visor's center of gravity is forward (toward the user) of the monitor is the main cause of the sagging shown in FIGS. 11A and 11B. The present invention is a visor with a center of gravity forward of the monitor but which overcomes this sagging problem by providing support tabs 81 and 82 which prevent sagging and maintain the vertical orientation of side walls 31,32 and side panels 71,72.

The first embodiment (FIGS. 1-3) includes a generally rectangular top member 21 and first and second generally L-shaped side walls 31 and 32. Means shown generally as 50 are provided for slidably connecting the first and second side walls 31 and 32 with top member 21 to form a three part shield for the screen 7, the three part shield extending perpendicularly to the screen and extending forwardly of the screen plane, i.e., in a direction toward the user. The means 50 for connecting side walls 31 and 32 to top member 21 may be a rolled U-form channel as shown in greater detail in patent 4,444,465.

Means shown generally as 60 are also provided for connecting the first and second side walls 31 and 32 and top member 21 to computer monitor 5. Means 60 may include three adhesive tabs 61, 62 and 63.

First and second side panels 71 and 72 are carried by first and second side walls 31 and 32, respectively. First and second side panels 71 and 72 extend in planes generally parallel with the screen plane and the side panels 71 and 72 are adapted to support documents in planes generally parallel with the screen plane by supporting removable clips 73 and 74.

Side panels 71 and 72 are preferably integrally formed with first and second side walls 31 and 32 to provide a continuous shroud which tends to block light from impinging on the screen 7 which would cause glare as well as light emanating from behind the screen plane which would otherwise impinge directly on the user's eyes, causing unwanted constriction of the pupils. First and second side panels 71 and 72 are positioned adjacent to and at the same height as screen 7 to facilitate the user moving his or her eyes from a reference document carried by either side panel and on to screen 7.

Support tabs 81 and 82 are formed from the lower, rear corners of first and second side walls 31 and 32, respectively. Support tabs 81 and 82 have bend lines 83 and 84 which extend vertically adjacent the front wall 85 of monitor 5. The purpose of support tabs 81 and 82 is to prevent the sagging of the visor 10 that would otherwise occur, as shown in FIGS. 11A and 11B, since the center of gravity of visor 10 is forward of front wall 85 of monitor 5 (i.e. between the front wall 85 and the user).

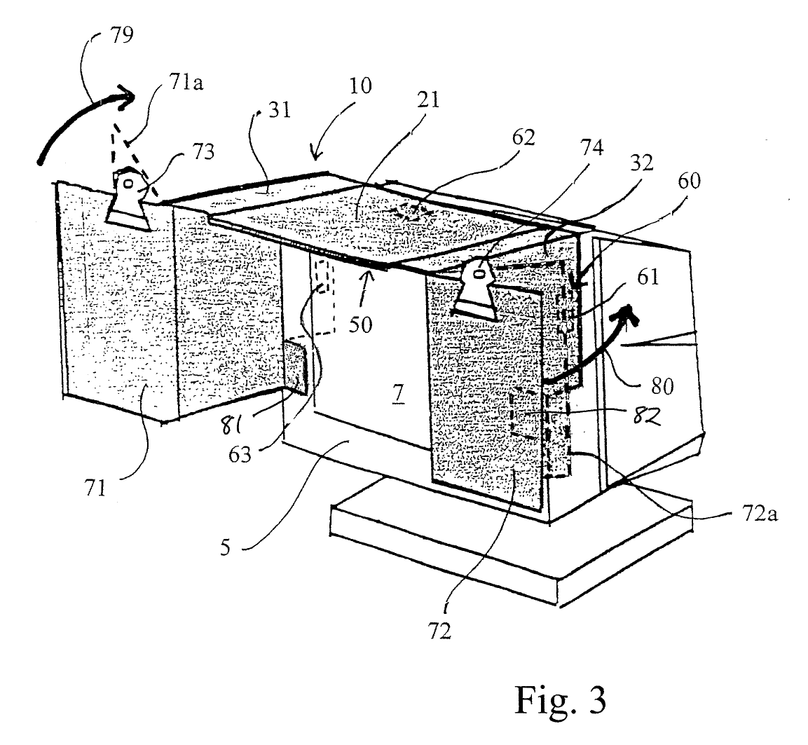

FIG. 3 illustrates how the first embodiment 10 of the present invention preferably provides a hinged connection between side panel 71 and first side wall 31 so that side panel 71 may be folded back against side wall 31 as shown by the arrow 79 and in phantom showing side panel 71a partially folded back against side wall 31. The hinged connection may be a “living hinge” by utilizing appropriate materials or, alternately, may be simple mechanical hinges. Side panel 72 is also hingedly connected to side wall 32 and is foldable along the path shown by arrow 80 and as shown in phantom at 72a.

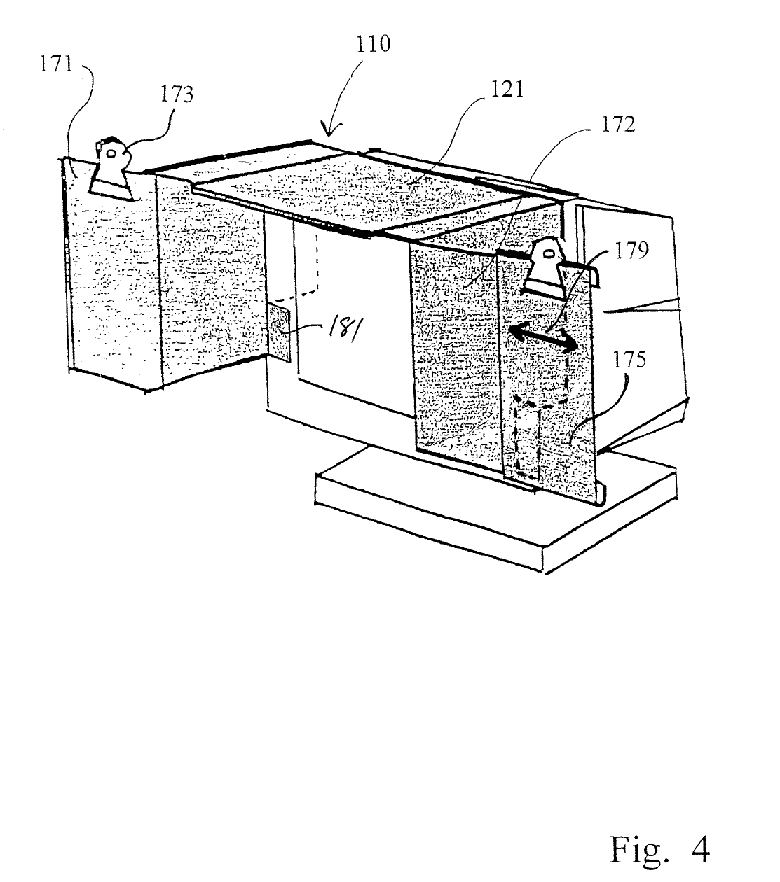

FIG. 4 illustrates a second embodiment of the invention shown generally as 110 which differs from the first embodiment in that second side panel 172 includes a telescopic extension piece 175 which allows the user to expand the overall width of second side panel 172. The first side panel 171 could similarly be modified to allow its width to be easily adjusted by the user. The width adjustment, as indicated by arrow 179, provides additional reduction of glare and further reduces background light from impinging on the user's eyes. It also allows larger documents to be supported on its surface. Support tabs 181 and 182 maintain visor 110 in its vertical position.

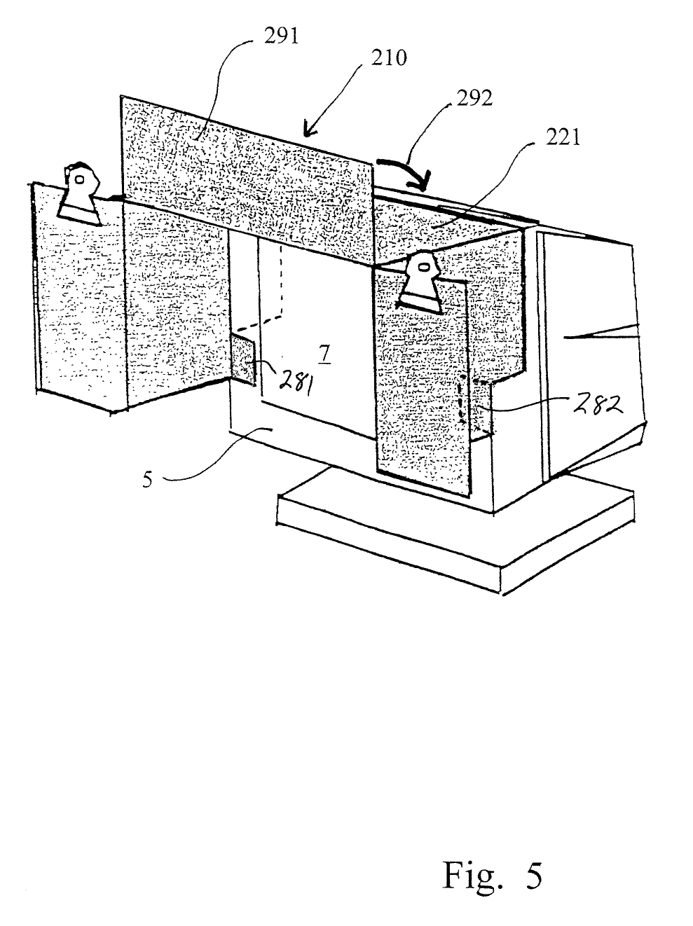

FIG. 5 shows a third embodiment of the invention shown generally as 210. This embodiment includes a top panel 291 carried by top member 221, the top panel 291 extending in a plane parallel to the screen plane. Top panel 291 is preferably hingedly connected to top member 221 and may be readily folded backward and downwardly in the direction of arrow 292 to a position where it lies adjacent to and parallel with top member 221. Top panel 291 provides additional surface area for reducing glare and background light which would otherwise impinge directly on the user's eyes. Support tabs 281 and 282 hold visor 210 in its vertical position.

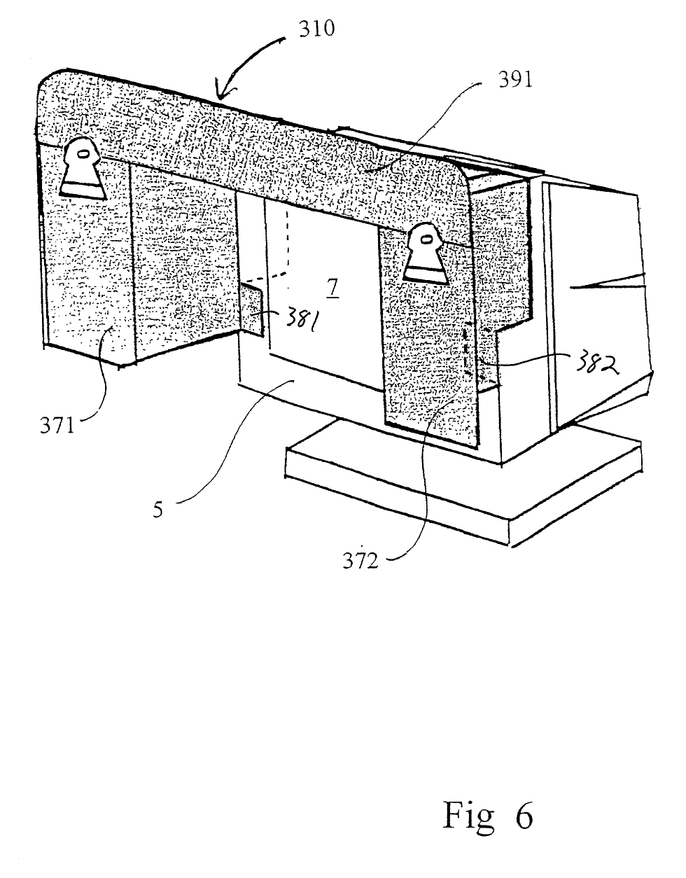

A fourth embodiment 310 is shown in FIG. 6 having a wider top panel 391 which extends, not only across the width of the computer monitor 5, but also extends across the width of first and second side panels 371 and 372. Support tabs 381 and 382 are provided to prevent sagging of visor 310.

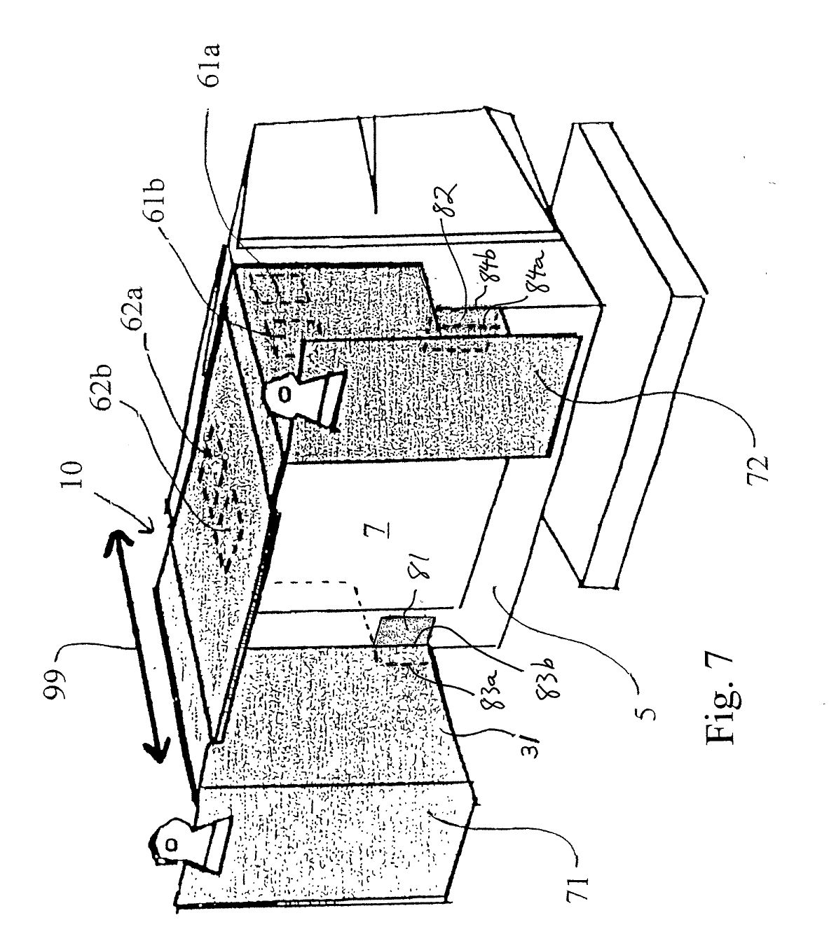

FIG. 7 shows an alternate feature which may be incorporated on the first embodiment visor shown generally as 10. The alternate feature is a plurality of adhesive mounting tabs which allows the visor 10 to be moved in the direction of arrow 99 perpendicularly to the screen plane. To allow this adjustability, a plurality of adhesive mounting tabs 61a and 61b replaces the single mounting tab 61 as illustrated in FIG. 1. Similarly, a plurality of mounting tabs 62a and 62b are applied to top member 21 and a plurality of adhesive tabs is also applied to L-shaped side wall 31. Support tabs 81 and 82 have score lines 83a,83b and 84a,84b to facilitate different positions of visor 10 relative to the screen plane.

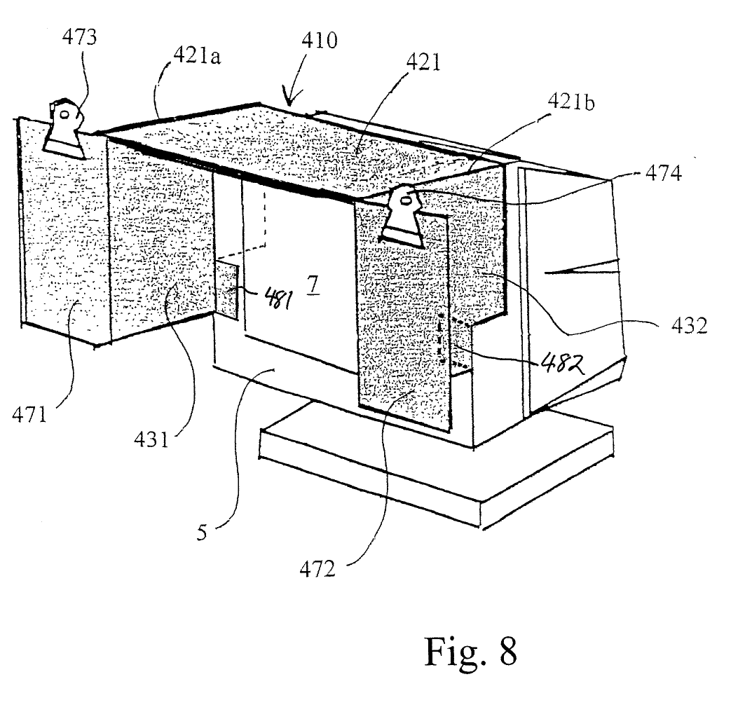

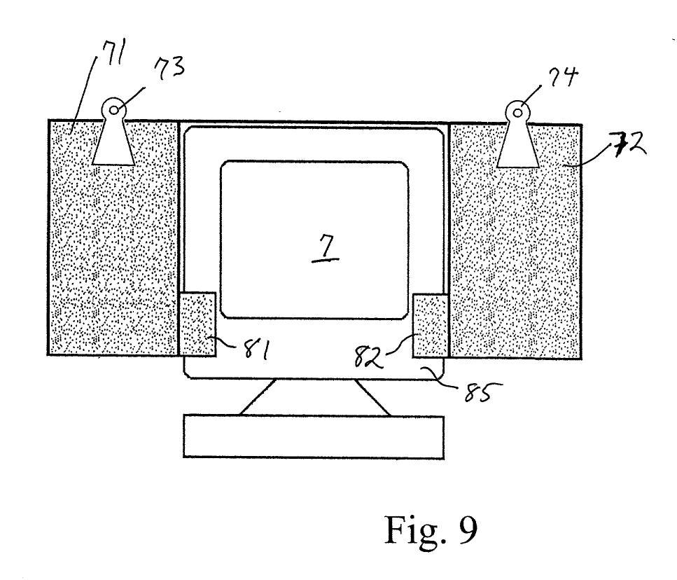

FIG. 8 shows a fifth embodiment 410 which is essentially an integrally formed clipboard visor made to fit computer monitor 5. A generally rectangular top member 421 is made of the same sheet of material as side walls 431 and 432. Bend lines 421a and 421b are fabricated a fixed and predetermined distance apart which corresponds to the width of computer monitor 5, so that, when the visor and document holder 410 is folded along lines 421a and 421b, it will be an appropriate shape to fit snugly against the top and side walls of computer monitor 5. Adhesive tabs are provided similar to the embodiment shown in FIGS. 1, 2 and 3 to attach the visor and document holder to the monitor 5 but are not shown in FIG. 9 for clarity. The top member 421 and side walls 431 and 432 form a three part shield for the screen 7 extending perpendicular to the screen plane and extending forwardly of the screen plane. First and second side panels 471 and 472 are carried by side walls 431 and 432 and extend in planes generally parallel with the screen plane and panels 471 and 472 are adapted to support documents in planes parallel with the screen plane by clips 473 and 474. Support tabs 481 and 482 are also provided.

It is to be understood that the present invention may be manufactured from a variety of materials, including plastic, paper or metal. The preferred composition would be molded plastic that provides a “living hinge” capability. Alternate means can be utilized to connect the first and second L-shaped side walls to the top member and alternate means may be provided 9 for connecting the visor to the computer monitor cabinet. Other variations in the design may be made without departing from the invention.

What is claimed is:

1. A visor and document holder for a computer monitor, wherein said monitor includes a front wall and a screen lying in a screen plane, comprising:
a generally rectangular top member, first and second generally L-shaped side walls,
means for slidably connecting said first and second side walls to said top member whereby said first and second side walls and said top member form a three part shield for said screen extending perpendicularly to said screen plane and extending forwardly of said screen plane,
means for connecting said first and second side walls and said top member to said monitor,
first and second side panels carried by said first and second side walls,
respectively, said first and second side panels extending in planes generally parallel with said screen plane, and said first and second side panels being adapted to support documents in planes generally parallel with said screen plane, and
first and second support tabs formed in the lower, rear corner of each of said first and second side walls, each of said support tabs extending in a plane parallel to said screen plane and contacting said front wall of said monitor to prevent sagging of said visor and document holder.

2. The apparatus of claim 1 further comprising a top panel carried by said top member, said top panel extending in a plane generally parallel with said screen plane.

3. The apparatus of claim 1 wherein said first and second side panels are each comprised of a pair of telescoping, slidable sections to allow adjustment of the width of said first and second side panels.

4. The apparatus of claim 1 wherein said first and second side panels are hingedly connected to said first and second side walls.

5. The apparatus of claim 1 wherein the center of gravity of said visor and document holder is forward of said screen plane and said front wall of said monitor, and wherein said side panels are oriented vertically and said support tabs maintain the vertical orientation of said side panels.
